(19) United States
(12) Patent Application Publication
(10) Pub. No.: US 2025/0267080 A1
(43) Pub. Date: Aug. 21, 2025

(54) ADAPTIVE MONITORING OF RADIO INTELLIGENT CONTROLLER KEY PERFORMANCE INDICATORS

(71) Applicant: LENOVO (SINGAPORE) PTE. LTD., Singapore (SG)

(72) Inventors: Matheus Fagundes de Souza Dória, Parnamirim (BR); Carlos Antonio De Lima Filho, Natal (BR); Daniel Rodrigues de Luna, Parnamirim (BR); Allan de Medeiros Martins, Natal (BR); Vicente Angelo de Sousa, JR., Natal (BR); Marcos Rogério Salvador, Americana (BR); Marcelo Augusto Costa Fernandes, Natal (BR); Guilherme de Magalhães Púpio, Sao Jose dos Campos (BR)

(73) Assignee: LENOVO (SINGAPORE) PTE. LTD., Singapore (SG)

(21) Appl. No.: 18/442,246

(22) Filed: Feb. 15, 2024

(51) Int. Cl. H04L 41/5009; H04W 24/08

(52) U.S. Cl. CPC H04L 41/5009; H04W 24/08

(57) ABSTRACT

Various aspects of the present disclosure relate to adaptive monitoring of radio intelligent controller (RIC) key performance indicators (KPIs). An apparatus, such as a RIC, receives performance data of one or more KPIs. The RIC updates a sampling rate of at least one KPI based at least in part on a determination to mitigate use of one or more operational resources of the RIC, where the determination includes a quantized risk evaluation for adjusting the sampling rate of the at least one KPI. The RIC can transmit an indication of an updated sampling rate for the at least one KPI to a network equipment (NE) and/or to a wireless access point for communication to a user equipment (UE).

### TECHNICAL FIELD

The present disclosure relates to wireless communications, and more specifically to an open radio access network (RAN).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, open RAN is an evolution of the next generation radio access network (NG-RAN) architecture, and may support various features for disaggregated deployment of mobile fronthaul and midhaul networks. Open RAN is intended to support interoperation between different wireless network equipment and devices for flexibility and interoperability in a wireless communications system, such as by use of open interfaces.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a radio access network (RAN) intelligent controller (RIC) for wireless communication to receive performance data of a key performance indicator (KPI). The RIC updates a sampling rate of the KPI based at least in part on a determination to mitigate use of one or more operational resources of the RIC, where the determination includes a quantized risk evaluation for adjusting the sampling rate of the KPI.

In some implementations of the method and apparatuses described herein, the RIC transmits an indication of an updated sampling rate for the KPI to a network equipment (NE). The quantized risk evaluation assesses at least one of variation of the performance data of the KPI, or risk of the performance data of the KPI. A relatively low variation of the performance data correlates with a decreased sampling rate of the KPI, and a relatively high variation of the performance data correlates with an increased sampling rate of the KPI. Additionally, or alternatively, a relatively low risk of the performance data correlates with a decreased sampling rate of the KPI, and a relatively high risk of the performance data correlates with an increased sampling rate of the KPI. The one or more operational resources of the RIC include at least one of processor performance, memory operations, data throughput, a bit rate, data bus bandwidth, energy consumption, or RIC performance. Additionally, or alternatively, the update to the sampling rate of the KPI is based at least in part on the determination to mitigate use of one or more additional resources that include at least one of transport network performance, a UE performance, or wireless system performance. The one or more operational resources of the RIC include at least processor performance, and wherein the quantized risk evaluation assesses a combination of the performance data of the KPI and the processor performance of the RIC.

Additionally, or alternatively, the RIC receives the performance data of multiple KPIs, and the quantized risk evaluation assesses the performance data for a combination of KPIs of the multiple KPIs. Additionally, or alternatively, the RIC receives the performance data of the KPI via an open radio access network interface. Additionally, or alternatively, the RIC receives the performance data of the KPI from a NE, and transmits an indication of an updated sampling rate for the KPI to the NE. Additionally, or alternatively, the RIC receives the performance data of the KPI from a UE via a wireless access point, and transmits an indication of an updated sampling rate for the KPI to the wireless access point. The KPI is associated with at least one of a physical (PHY) layer, a medium access control (MAC) layer, a radio link control (RLC) layer, a packet data convergence protocol (PDCP) layer, or a radio resource control (RRC) layer.

Some implementations of the method and apparatuses described herein may further include a processor for wireless communication to receive performance data of a KPI, and update a sampling rate of the KPI based at least in part on a determination to mitigate use of one or more operational resources of a RIC, the determination including a quantized risk evaluation for adjusting the sampling rate of the KPI. Additionally, or alternatively, the controller causes the processor to transmit an indication of an updated sampling rate for the KPI to a NE.

Some implementations of the method and apparatuses described herein may further include a method performed by a RIC, the method including receiving performance data of one or more KPIs, and updating a sampling rate of at least one KPI based at least in part on a determination to mitigate use of one or more operational resources of the RIC, the determination including a quantized risk evaluation for updating the sampling rate of the at least one KPI.

In some implementations of the method and apparatuses described herein, the quantized risk evaluation includes assessing variation of the performance data for a combination of the one or more KPIs. The one or more operational resources of the RIC include at least one of processor performance, memory operations, data throughput, a bit rate, data bus bandwidth, energy consumption, or RIC performance. The method including receiving the performance data of the one or more KPIs from a NE, and transmitting an indication of an updated sampling rate for the one or more KPIs to the NE. Additionally, or alternatively, the method including receiving the performance data of the one or more KPIs from a UE via a wireless access point, and transmitting an indication of an updated sampling rate for the one or more KPIs to the wireless access point.

### BRIEF DESCRIPTION OF THE DRAWINGS

FIG. 1 illustrates an example of a wireless communications system in accordance with aspects of the present disclosure.

FIG. 2 illustrates an example of an open RAN system, in accordance with aspects of the present disclosure.

FIG. 3 illustrates an example of a KPI evaluation and adaptive sampling diagram, in accordance with aspects of the present disclosure.

FIG. 4 illustrates an example of a RIC in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIGS. 7-10 illustrate flowcharts of methods performed by a RIC in accordance with aspects of the present disclosure.

### DETAILED DESCRIPTION

A wireless communications system may include aspects of an open RAN architecture, such as a RIC, which can be implemented as a central software component of the open RAN architecture. In implementations, the RIC controls and optimizes RAN functions and resources. The open RAN 5G architecture can include aspects of a NR network, such as a 5G network, and a RIC. A first type of RIC may be implemented in service and management orchestration (SMO) in the 3GPP domain, such as centrally on an operator network in the wireless communications system to handle non-real time (non-RT) events. A second type of RIC may be implemented as a near-real time (near-RT) RIC, which operates in the O-RAN domain, such as on a network edge server, to process and handle events that require a response from ten (10) to one-hundred (100) milliseconds (ms).

The near-RT RIC hosts microservice-based applications, commonly referred to as xApps, which process in near-real time to optimize signaling overhead and enhance the RAN's spectrum efficiency. Similarly, a non-RT RIC may host other microservice-based applications, commonly referred to as rApps. The RIC signaling, efficiency, and/or operational resource usage may be monitored and evaluated based on one or more KPIs, which may be monitored internally in the RIC and/or obtained from the perspective of one or more base stations and/or from one or more UEs in the wireless communications system. In implementations, the operational resources of the RIC can include any one or combination of processor performance, memory operations, data throughput, a bit rate, data bus bandwidth, energy consumption, and/or RIC performance. Additionally, or alternatively, additional monitored resources may include transport network performance, a UE performance, and/or wireless system performance. In one or more implementations, the various KPIs may be associated with a PHY layer, a MAC layer, a RLC layer, a PDCP layer, and/or a RRC layer.

The open RAN 5G architecture also implements RAN functions and supports operator interfaces, such as the A1 and O1 interfaces to the non-RT RIC for the management and optimization of the RAN. The A1 interface supports a communication link between the non-RT RIC implemented in the SMO and the near-RT RIC for RAN optimization. The O1 interface supports connection of the SMO to open RAN network functions. However, open RAN RIC signaling overhead and hardware resource consumption may become problematic if the sampling frequency of one or a combination of the KPIs is higher than needed for optimized signaling overhead and efficiency. This may also be compounded due to the abundance of the KPIs that are available by the open RAN interfaces, as well as due to data applications, machine learning, and/or deep learning strategies for RIC solutions.

Aspects of the present disclosure are directed to adaptively monitoring and adjusting the respective sampling rates of one or more of the KPIs to optimize RIC signaling overhead and efficiency. The described techniques support determining the sampling time for each KPI such that the time granularity of KPI gathering can be dynamically updated based on risk evaluation in the RIC platform. In one or more implementations, the RIC can update the sampling rate of a KPI based on a determination to mitigate use of one or more operational resources of the RIC. The determination may include a quantized risk evaluation for adjusting the sampling rate of the KPI. For example, the quantized risk evaluation may include an assessment of a variation of the performance data of the KPI, or a risk of the performance data of the KPI. In implementations, a relatively low variation of the performance data correlates with a decreased sampling rate of the KPI, and correspondingly, a relatively high variation of the performance data correlates with an increased sampling rate of the KPI. Additionally, or alternatively, a relatively low risk of the performance data correlates with the decreased sampling rate of the KPI, and correspondingly, a relatively high risk of the performance data correlates with the increased sampling rate of the KPI.

By utilizing the techniques described in the present disclosure, a RIC can adaptively optimize signaling overhead for xApps, such as to reduce signaling overhead in terms of network data traffic, and conserve network bandwidth for payload transmissions. This may also result in reducing open RAN RIC hardware resource usage, as well as reduce energy consumption in network equipment (e.g., a network edge server) that implements components of the open RAN RIC. Although generally described throughout this disclosure in terms of a RIC in an open RAN network or platform (e.g., for both a non-RT RIC and a near-RT RIC), aspects of the described techniques may be applicable to any type of 4G or 5G radio access technology, as well as Wi-Fi open networks.

Aspects of the present disclosure are described in the context of a wireless communications system, and more specifically to open RAN.

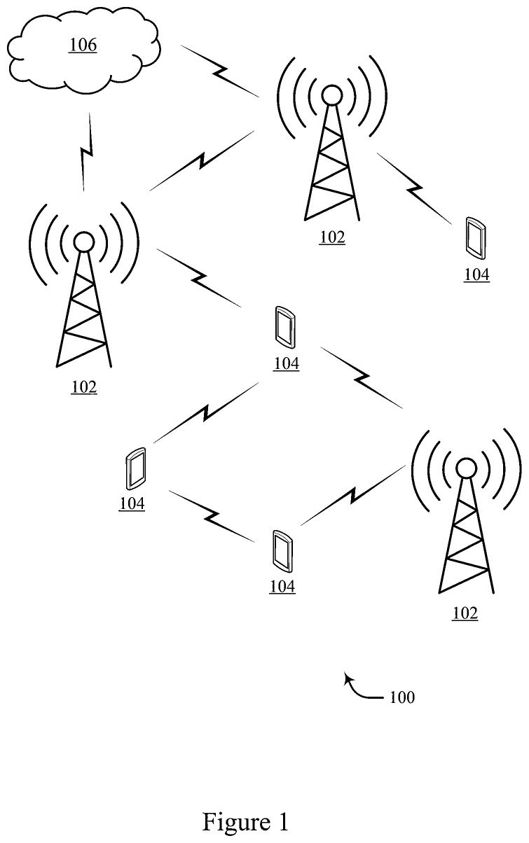

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), a wireless access point, or other suitable terminology. An NE 102 and a UE 104 may communicate via a communication link, which may be a wireless or wired connection, and may include communicating via a wireless access point. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (near-RT RIC), a non-real time RIC (non-RT RIC)), a SMO system, or any combination thereof.

According to implementations, one or more of the network entities 102 and/or the UEs 104 are operable to implement various aspects of the techniques described with reference to the present disclosure. For example, a network entity 102 implemented for open RAN with a near-RT RIC receives performance data of one or more KPIs. The RIC can update a sampling rate of a KPI based on a determination to mitigate use of one or more operational resources of the RIC, where the determination includes a quantized risk evaluation for adjusting the sampling rate of the KPI. The RIC can receive or obtain the performance data of the one or more KPIs, and the quantized risk evaluation may assess the performance data for a combination or multiple KPIs. The RIC can receive the performance data of the one or more KPIs from a NE, and transmit an indication of an updated sampling rate for a KPI to the NE. Additionally, or alternatively, the RIC can receive the performance data of the one or more KPIs from a UE via a wireless access point, and transmit an indication of an updated sampling rate for a KPI back to the wireless access point.

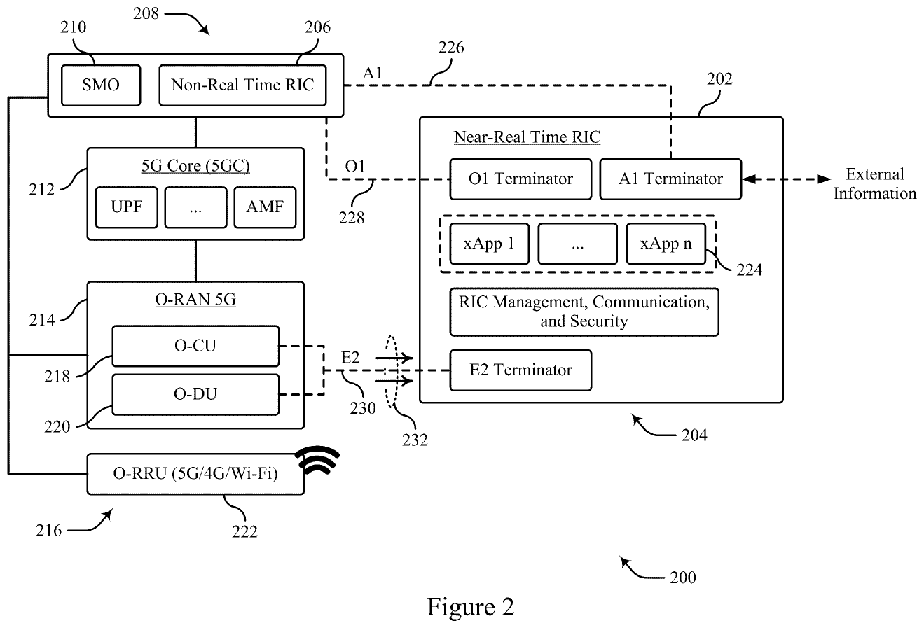

FIG. 2 illustrates an example of an open RAN system 200 in accordance with aspects of the present disclosure. In this example, the system 200 is illustrative of open RAN 5G, which includes aspects of a NR network, such as a 5G network, and a near-RT RIC 202. In the system, an O-RAN domain 204 includes the near-RT RIC 202 and a non-RT RIC 206. The RIC (e.g., the near-RT RIC 202 and non-RT RIC 206) is the central software component of the open RAN system 200, and controls and optimizes RAN functions and resources. Additionally, a 3GPP domain 208 includes SMO 210, a 5G core (5GC) 212, and O-RAN 5G 214. Additionally, an O-RAN plus 3GPP domain 216 includes an O-RAN central unit (O-CU) 218 and an O-RAN distributed unit (O-DU) 220 of the O-RAN 5G 214, as well as an O-RAN remote radio unit (O-RRU) 222 for 5G, 4G, and/or Wi-Fi.

The near-RT RIC 202 hosts one or more xApps 224 (e.g., xApp 1 . . . xApp n), which are microservice-based applications that process in near-real time to optimize signaling overhead and enhance the RAN efficiency. The open RAN system 200 includes operator interfaces, such as the A1 interface 226 and the O1 interface 228, which are interfaces to the non-RT RIC 206 for the management and optimization of the RAN system. The A1 interface 226 supports a communication link between the non-RT RIC 206 implemented in the SMO 210 and the near-RT RIC 202 for RAN optimization. The O1 interface 228 supports connection of the SMO 210 to open RAN network functions.

The open RAN system 200 also includes an E2 interface 230, which is a logical interface connecting the near-RT RIC 202 with an E2 node of the O-RAN 5G 214. In implementations, the near-RT RIC 202 can be connected to multiple E2 nodes, via which performance data of KPIs is obtained by the near-RT RIC. The protocols over the E2 interface 230 are based on control plane protocols, and E2 services are grouped into categories, including near-RT RIC services (e.g., report, insert, control, and policy); near-RT RIC support functionalities, which include E2 interface management (e.g., E2 setup, E2 reset, reporting of general error situations, etc.); and near-RT RIC service update as capability exchange related to the list of E2 node services exposed over E2, etc.

The near-RT RIC 202 is an O-RAN network function (NF) that enables near real-time control and optimization of services and resources of E2 nodes via fine-grained data collection and actions over the E2 interface 230 with control loops in the order of ten (10) milliseconds (ms) to one second. The near-RT RIC 202 hosts the one or more xApps 224 that use the E2 interface 230 to collect near real-time information (e.g., on a UE basis or a cell basis) and provide value added services. The near-RT RIC control over the E2 nodes is guided via the policies and data received via the A1 interface 226 from the non-RT RIC 206. Based on the available data, the near-RT RIC 202 generates the RAN analytics information, which may then be exposed via a Y1 interface and/or transmitted to a NE or back to a UE via a wireless access point.

In aspects of the described techniques, RIC signaling, efficiency, and/or operational resource usage may be monitored and evaluated based on one or more KPIs 232, which may be monitored internally in the near-RT RIC 202 and/or obtained from the perspective of base stations and/or from UEs in the open RAN system 200. In one or more implementations, the various KPIs may be associated with a PHY layer, a MAC layer, a RLC layer, a PDCP layer, and/or a RRC layer. For example, PHY layer KPIs may be associated with downlink (DL) synchronization signal-based reference signal received power (SS-RSRP); uplink (UL) sounding reference signal-based reference signal received power (SRS-RSRP); DL reference signal received quality (RSRQ), and other various PHY layer KPIs. The MAC layer KPIs may be associated with DL and UL aggregated transport blocks (TBS); physical uplink shared channel (PUSCH) SNR; physical uplink control channel (PUCCH) SNR; channel quality indicator (CQI); modulation and coding scheme (MCS); block error rate (BLER); and other various MAC layer KPIs.

In further examples, the RLC layer KPIs may be associated with transmitted protocol data units (PDU) packets or bytes; retransmitted PDU packets or bytes; current transmit (Tx) buffer occupancy (packets or bytes); bytes received by the radio link control (RLC) PDUs; a number of receive (Rx) packets dropped or discarded by RLC; and other various RLC layer KPIs. The PDCP layer KPIs may be associated with transmitted PDU packets or bytes; received PDU packets or bytes; a number of out-of-order Rx packets or bytes; a number of discarded packets or bytes; a number of SDUs received; and other various PDCP layer KPIs. The RRC layer KPIs may be associated with a RRC inactivity timer, a RRC connection request, SL UE information, and other various RRC layer KPIs.

In aspects of the described techniques, the near-RT RIC 202 receives or obtains the performance data of one or more KPIs 232. In implementations, one or more of the KPIs 232 may be obtained from internal processes of the near-RT RIC 202. Additionally, or alternatively, one or more of the KPIs 232 can be received via the E2 interface 230 from a NE, or received from a UE via a wireless access point. In one or more implementations, an xApp 224 of the near-RT RIC 202 receives the performance data of a KPI 232 and can determine to adjust the sampling rate of the KPI, such as to mitigate the use of one or more operational resources of the near-RT RIC. For example, the operational resources of the near-RT RIC 202 can include any one or combination of processor performance, memory operations, data throughput, a bit rate, data bus bandwidth, energy consumption, and/or RIC performance.

The near-RT RIC 202 can update the sampling rate of the KPI 232 based on the determination by an xApp to mitigate use of the one or more operational resources of the near-RT RIC. The dynamic assessment of the sample rate of a KPI 232 may be periodic as the performance data of the KPI is obtained or received. In implementations, the variable sample rate is based on risk evaluation indications that characterize KPI accuracy, and can be dynamically determined or assessed for the best sampling rate for each KPI, such as to mitigate the signaling overhead in open RAN applications in an adaptive manner to conserve resources at the near-RT RIC.

The determination to update the sampling rate of the KPI 232 includes a quantized risk evaluation for adjusting the sampling rate of the KPI. The quantized risk evaluation can include an assessment of a variation of the performance data of the KPI 232, or a risk of the performance data of the KPI. In implementations, A relatively low variation of the performance data correlates with a decreased sampling rate of the KPI, and a relatively high variation of the performance data correlates with an increased sampling rate of the KPI. Additionally, or alternatively, a relatively low risk of the performance data correlates with a decreased sampling rate of the KPI, and a relatively high risk of the performance data correlates with an increased sampling rate of the KPI.

In implementations, the quantized risk evaluation may be based on variation of one or more KPIs 232 received via the E2 interface 230, such as associated with infrastructure-related information (e.g., CPU and memory consumption, hardware overheating, and other various operational aspects of the near-RT RIC). Additionally, or alternatively, the quantized risk evaluation may be based on an assurance of combined metrics that may affect user satisfaction (e.g., target values for throughput, latency, and packet loss ratio for data transmission). Additionally, or alternatively, the quantized risk evaluation may be based on other factors that may affect user satisfaction (e.g., target values for latency, jitter, effective latency, and packet loss for VoIP). Additionally, or alternatively, the quantized risk evaluation may be based on a quality of experience (e.g., peak SNR (PSNR), video quality metric (VQM) for video; R Factor (rating factor) and mean opinion score (MoS) for voice).

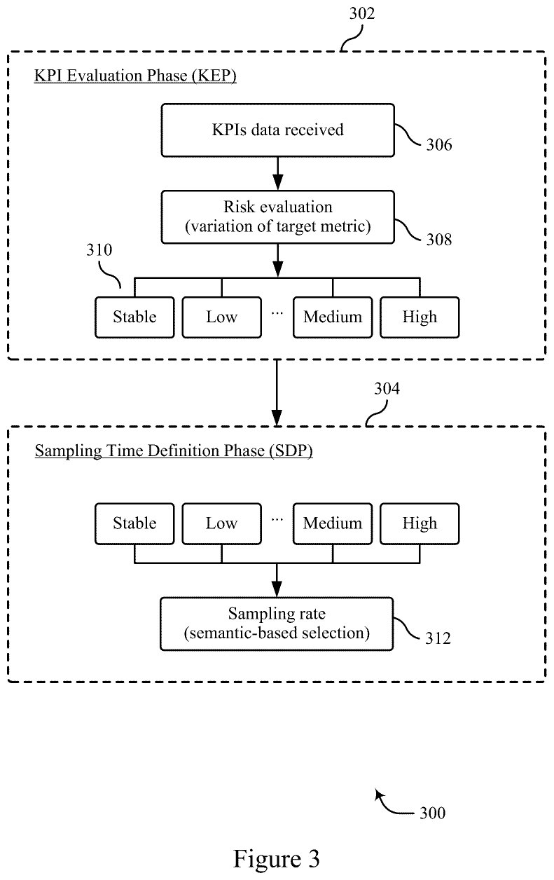

FIG. 3 illustrates an example of a KPI evaluation and adaptive sampling diagram 300 in accordance with aspects of the present disclosure. In this example, an xApp 224 of the near-RT RIC 202 can perform a quantized risk evaluation for adjusting the sampling rate of the KPI 232 in two phases that include a KPI evaluation phase (KEP) 302 and a sampling time definition phase (SDP) 304. As also described above with reference to FIG. 2, KPI performance data is received by an xApp 224 of the near-RT RIC 202 (at 306), such as via the E2 interface 230. Additionally, or alternatively, the performance data of one or more KPIs may be obtained from internal processes and/or applications of the near-RT RIC. At 308, the quantized risk evaluation is assessed or determined, such as a variation of a target metric (e.g., based on a time variation, a trend, a valuation, a statistical metric, etc.), a variation of the performance data of the KPI 232, or a risk of the performance data of the KPI.

At 310 of the KEP 302, the risk may be indicated as stable, low, medium, high, or as any other type of risk indication. For example, a relatively high risk may indicate that the performance data of a KPI 232 changes more often than for a determination of a relatively low risk (e.g., a more stable feedback). For a determination of a stable risk at 310, the sampling rate of the KPI may be updated or adjusted to sample at ten (10) ms intervals rather than at a higher rate. Correspondingly, for a determination of a high risk at 310, the sampling rate of the KPI may be updated or adjusted to sample more often, such as at one (1) ms intervals rather than at the lower rate. This is further indicated at 312 in the SDP 304, where the sampling rate is correlated with the indicated determination of risk (e.g., as stable, low, medium, high, or as any other type of risk indication). An example implementation is included below in Table 1 for KEP 302 and in Table 2 for the correlated SDP 304. Notably, the percentages, risk indications, and corresponding sampling times are merely examples, and any type of metrics, percentages, values, and/or indications may be implemented to represent the correlation of risk evaluation and KPI sampling time.

TABLE 1
KPI Evaluation Phase (KEP)

| Risk Evaluation: | Description: |
|---|---|
| 5% | Stable |
| 10% | Low |
| . . . | . . . |
| 20% | Medium |
| >20% | High |

TABLE 2
Sampling Time Definition Phase (SDP)

| Risk Evaluation: | Sampling Time: | |
|---|---|---|
| Stable | 10 | ms |
| Low | 5 | ms |
| . . . | . . . | |
| Medium | 2 | ms |
| High | 1 | ms |

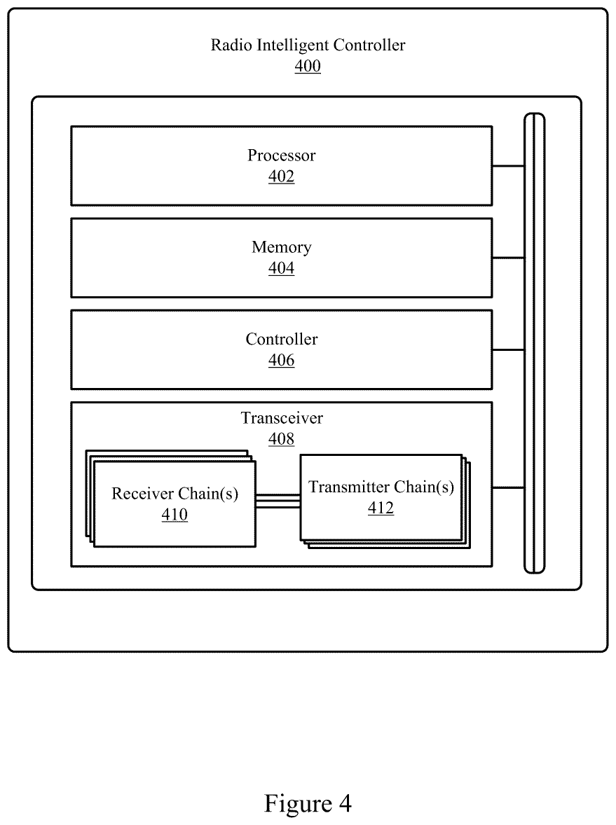

FIG. 4 illustrates an example of a RIC 400 in accordance with aspects of the present disclosure. The RIC 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the RIC 400 to perform various functions of the present disclosure.

The memory 404 may include volatile or non-volatile memory. The memory 404 may store computer-readable, computer-executable code including instructions when executed by the processor 402 cause the RIC 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the RIC 400 to perform one or more of the functions described herein (e.g., executing, by the processor 402, instructions stored in the memory 404). For example, the processor 402 may support wireless communication at the RIC 400 in accordance with examples as disclosed herein. The RIC 400 may be configured to or operable to support a means for receiving performance data of one or more KPIs; and updating a sampling rate of at least one KPI based at least in part on a determination to mitigate use of one or more operational resources of the RIC, the determination including a quantized risk evaluation for updating the sampling rate of the at least one KPI.

Additionally, the RIC 400 may be configured to support any one or combination of the quantized risk evaluation includes assessing variation of the performance data for a combination of the one or more KPIs. The quantized risk evaluation includes assessing risk of the performance data of the combination of the one or more KPIs. A relatively low risk of the performance data correlates with a decreased sampling rate of the KPI, and wherein a relatively high risk of the performance data correlates with an increased sampling rate of the KPI. The one or more operational resources of the RIC include at least one of processor performance, memory operations, data throughput, a bit rate, data bus bandwidth, energy consumption, or RIC performance. The update to the sampling rate of the KPI is based at least in part on the determination to mitigate use of one or more additional resources that include at least one of transport network performance, a UE performance, or wireless system performance. The one or more operational resources of the RIC include at least processor performance, and wherein the quantized risk evaluation assesses a combination of the performance data of the KPI and the processor performance of the RIC. The method further comprising receiving the performance data of the one or more KPIs from a NE; and transmitting an indication of an updated sampling rate for the one or more KPIs to the NE. The method further comprising receiving the performance data of the one or more KPIs from a UE via a wireless access point; and transmitting an indication of an updated sampling rate for the one or more KPIs to the wireless access point. The method further comprising transmitting an indication of an updated sampling rate for the KPI to a NE. The method further comprising receiving the performance data of the KPI via an open radio access network interface.

Additionally, or alternatively, the RIC 400 may support at least one memory and at least one processor coupled with the at least one memory and configured to cause the RIC to receive performance data of a KPI; and update a sampling rate of the KPI based at least in part on a determination to mitigate use of one or more operational resources of the RIC, the determination including a quantized risk evaluation for adjusting the sampling rate of the KPI.

Additionally, the RIC 400 may be configured to support any one or combination of the at least one processor is configured to cause the RIC to transmit an indication of an updated sampling rate for the KPI to a NE. The quantized risk evaluation assesses at least one of variation of the performance data of the KPI, or risk of the performance data of the KPI. A relatively low variation of the performance data correlates with a decreased sampling rate of the KPI, and a relatively high variation of the performance data correlates with an increased sampling rate of the KPI. A relatively low risk of the performance data correlates with a decreased sampling rate of the KPI, and a relatively high risk of the performance data correlates with an increased sampling rate of the KPI. The one or more operational resources of the RIC include at least one of processor performance, memory operations, data throughput, a bit rate, data bus bandwidth, energy consumption, or RIC performance. The update to the sampling rate of the KPI is based at least in part on the determination to mitigate use of one or more additional resources that include at least one of transport network performance, a UE performance, or wireless system performance. The one or more operational resources of the RIC include at least processor performance, and wherein the quantized risk evaluation assesses a combination of the performance data of the KPI and the processor performance of the RIC. The at least one processor is configured to cause the RIC to receive the performance data of multiple KPIs, and wherein the quantized risk evaluation assesses the performance data for a combination of KPIs of the multiple KPIs. The at least one processor is configured to cause the RIC to receive the performance data of the KPI via an open radio access network interface. The at least one processor is configured to cause the RIC to receive the performance data of the KPI from a NE, and transmit an indication of an updated sampling rate for the KPI to the NE. The at least one processor is configured to cause the RIC to receive the performance data of the KPI from a UE via a wireless access point, and transmit an indication of an updated sampling rate for the KPI to the wireless access point. The KPI is associated with at least one of a PHY layer, a MAC layer, a RLC layer, a PDCP layer, or a RRC layer.

The controller 406 may manage input and output signals for the RIC 400. The controller 406 may also manage peripherals not integrated into the RIC 400. In some implementations, the controller 406 may utilize an operating system such as iOS®, ANDROID®, WINDOWS®, or other operating systems. In some implementations, the controller 406 may be implemented as part of the processor 402.

In some implementations, the RIC 400 may include at least one transceiver 408. In some other implementations, the RIC 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

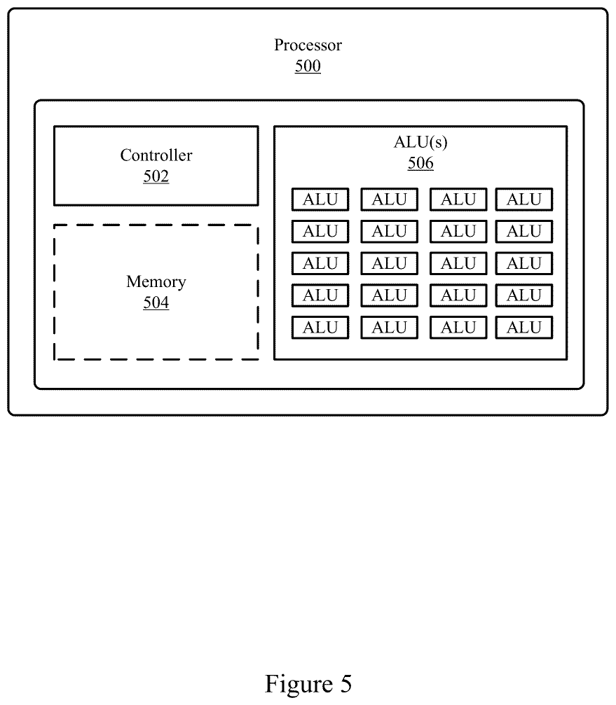

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller coupled with at least one memory and configured to cause the processor to receive performance data of a KPI; and update a sampling rate of the KPI based at least in part on a determination to mitigate use of one or more operational resources of a RIC, the determination including a quantized risk evaluation for adjusting the sampling rate of the KPI.

Additionally, the processor 500 may be configured to or operable to support any one or combination of the at least one controller is configured to cause the processor to transmit an indication of an updated sampling rate for the KPI to a NE. The quantized risk evaluation assesses at least one of variation of the performance data of the KPI, or risk of the performance data of the KPI. A relatively low variation of the performance data correlates with a decreased sampling rate of the KPI, and wherein a relatively high variation of the performance data correlates with an increased sampling rate of the KPI. A relatively low risk of the performance data correlates with a decreased sampling rate of the KPI, and wherein a relatively high risk of the performance data correlates with an increased sampling rate of the KPI. The one or more operational resources of the RIC include at least one of processor performance, memory operations, data throughput, a bit rate, data bus bandwidth, energy consumption, or RIC performance. The update to the sampling rate of the KPI is based at least in part on the determination to mitigate use of one or more additional resources that include at least one of transport network performance, a UE performance, or wireless system performance. The one or more operational resources of the RIC include at least processor performance, and wherein the quantized risk evaluation assesses a combination of the performance data of the KPI and the processor performance of the RIC. The at least one processor is configured to cause the RIC to receive the performance data of multiple KPIs, and wherein the quantized risk evaluation assesses the performance data for a combination of KPIs of the multiple KPIs. The at least one processor is configured to cause the RIC to receive the performance data of the KPI via an open radio access network interface. The at least one processor is configured to cause the RIC to receive the performance data of the KPI from a NE, and transmit an indication of an updated sampling rate for the KPI to the NE. The at least one processor is configured to cause the RIC to receive the performance data of the KPI from a UE via a wireless access point, and transmit an indication of an updated sampling rate for the KPI to the wireless access point. The KPI is associated with at least one of a PHY layer, a MAC layer, a RLC layer, a PDCP layer, or a RRC layer.

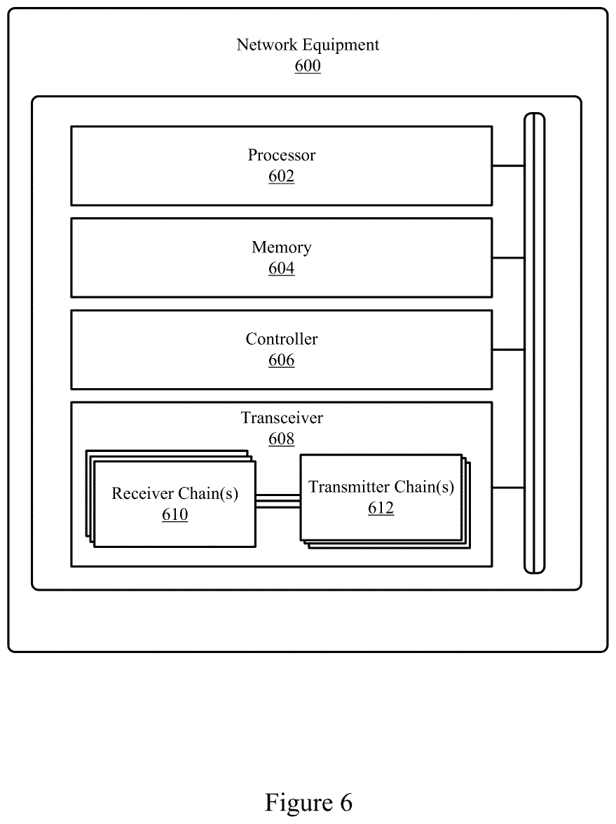

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting, to a RIC, performance data of a KPI; and receiving an indication of an updated sampling rate for the KPI, the sampling rate of the KPI updated by the RIC based at least in part on a determination to mitigate use of one or more operational resources of the RIC, and the determination including a quantized risk evaluation for adjusting the sampling rate of the KPI.

Additionally, or alternatively, the NE 600 may support at least one memory and at least one processor coupled with the at least one memory and configured to cause the NE to transmit, to a RIC, performance data of a KPI; and receive an indication of an updated sampling rate for the KPI, the sampling rate of the KPI updated by the RIC based at least in part on a determination to mitigate use of one or more operational resources of the RIC, and the determination including a quantized risk evaluation for adjusting the sampling rate of the KPI.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

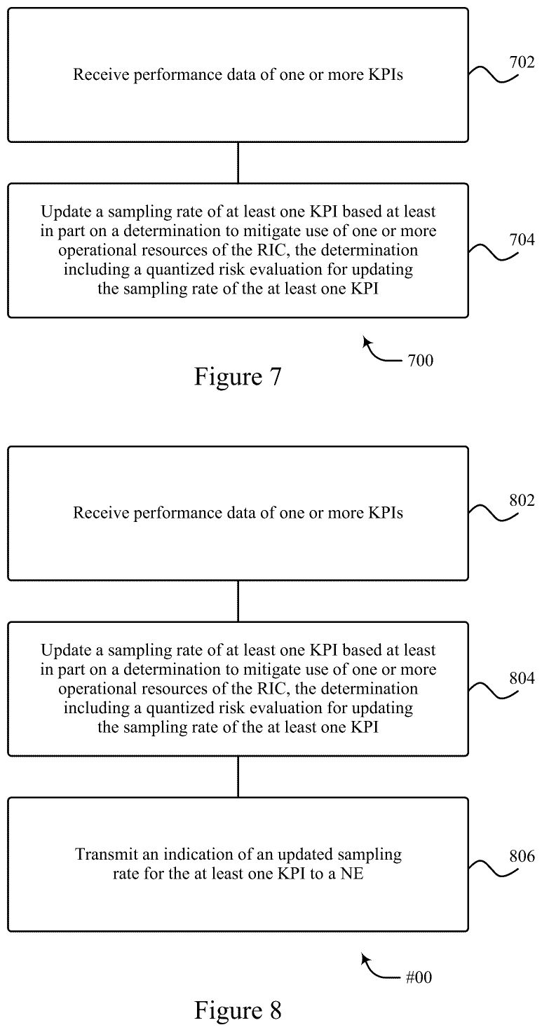

FIG. 7 illustrates a flowchart of a method 700 in accordance with aspects of the present disclosure. The operations of the method may be implemented by a RIC as described herein. In some implementations, the RIC may execute a set of instructions to control the function elements of the RIC to perform the described functions. It should be noted that the method described herein describes a possible implementation, and that the operations and the steps may be rearranged or otherwise modified and that other implementations are possible.

At 702, the method may include receiving performance data of one or more KPIs. The operations of 702 may be performed in accordance with examples as described herein. In some implementations, aspects of the operations of 702 may be performed by a RIC as described with reference to FIG. 4.

At 704, the method may include updating a sampling rate of at least one KPI based at least in part on a determination to mitigate use of one or more operational resources of the RIC, the determination including a quantized risk evaluation for updating the sampling rate of the at least one KPI. The operations of 704 may be performed in accordance with examples as described herein. In some implementations, aspects of the operations of 704 may be performed by a RIC as described with reference to FIG. 4.

FIG. 8 illustrates a flowchart of a method 800 in accordance with aspects of the present disclosure. The operations of the method may be implemented by a RIC as described herein. In some implementations, the RIC may execute a set of instructions to control the function elements of the RIC to perform the described functions. It should be noted that the method described herein describes a possible implementation, and that the operations and the steps may be rearranged or otherwise modified and that other implementations are possible.

At 802, the method may include receiving performance data of one or more KPIs. The operations of 802 may be performed in accordance with examples as described herein. In some implementations, aspects of the operations of 802 may be performed by a RIC as described with reference to FIG. 4.

At 804, the method may include updating a sampling rate of at least one KPI based at least in part on a determination to mitigate use of one or more operational resources of the RIC, the determination including a quantized risk evaluation for updating the sampling rate of the at least one KPI. The operations of 804 may be performed in accordance with examples as described herein. In some implementations, aspects of the operations of 804 may be performed by a RIC as described with reference to FIG. 4.

At 806, the method may include transmitting an indication of an updated sampling rate for the KPI to a NE. The operations of 806 may be performed in accordance with examples as described herein. In some implementations, aspects of the operations of 806 may be performed a RIC as described with reference to FIG. 4.

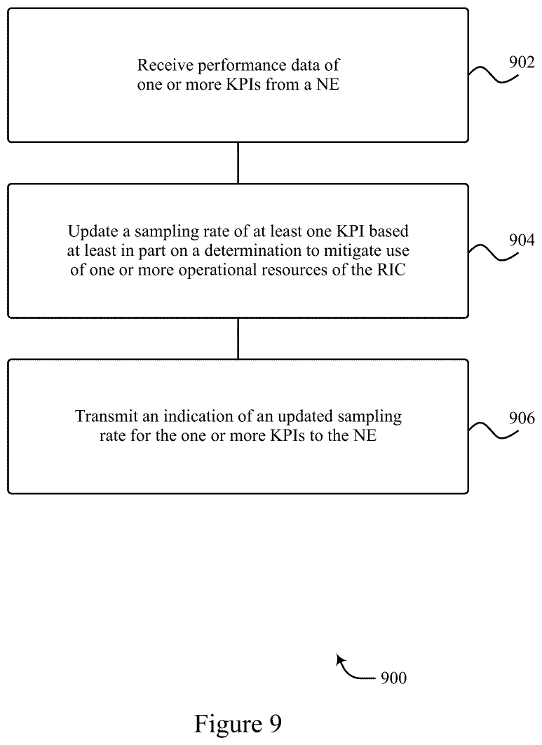

FIG. 9 illustrates a flowchart of a method 900 in accordance with aspects of the present disclosure. The operations of the method may be implemented by a RIC as described herein. In some implementations, the RIC may execute a set of instructions to control the function elements of the RIC to perform the described functions. It should be noted that the method described herein describes a possible implementation, and that the operations and the steps may be rearranged or otherwise modified and that other implementations are possible.

At 902, the method may include receiving performance data of one or more KPIs from a NE. The operations of 902 may be performed in accordance with examples as described herein. In some implementations, aspects of the operations of 902 may be performed by a RIC as described with reference to FIG. 4.

At 904, the method may include updating a sampling rate of at least one KPI based at least in part on a determination to mitigate use of one or more operational resources of the RIC. The operations of 904 may be performed in accordance with examples as described herein. In some implementations, aspects of the operations of 904 may be performed by a RIC as described with reference to FIG. 4.

At 906, the method may include transmitting an indication of an updated sampling rate for the one or more KPIs to the NE. The operations of 906 may be performed in accordance with examples as described herein. In some implementations, aspects of the operations of 906 may be performed a RIC as described with reference to FIG. 4.

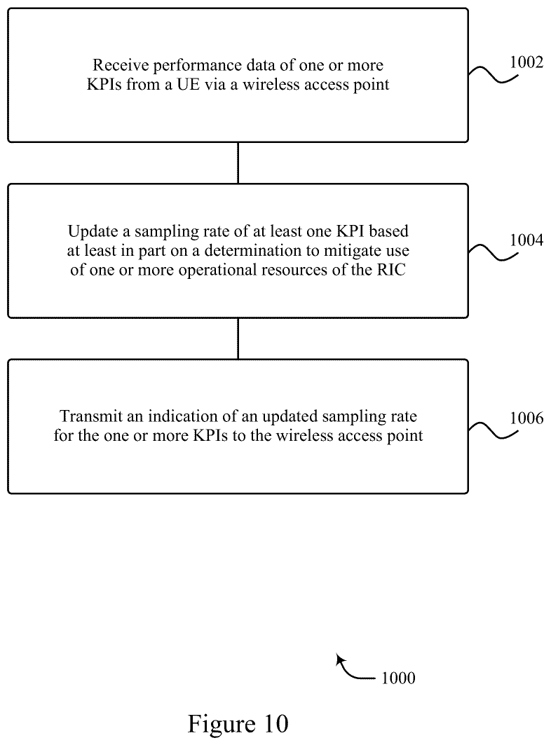

FIG. 10 illustrates a flowchart of a method 1000 in accordance with aspects of the present disclosure. The operations of the method may be implemented by a RIC as described herein. In some implementations, the RIC may execute a set of instructions to control the function elements of the RIC to perform the described functions. It should be noted that the method described herein describes a possible implementation, and that the operations and the steps may be rearranged or otherwise modified and that other implementations are possible.

At 1002, the method may include receiving performance data of one or more KPIs from a UE. The operations of 1002 may be performed in accordance with examples as described herein. In some implementations, aspects of the operations of 1002 may be performed by a RIC as described with reference to FIG. 4.

At 1004, the method may include updating a sampling rate of at least one KPI based at least in part on a determination to mitigate use of one or more operational resources of the RIC. The operations of 1004 may be performed in accordance with examples as described herein. In some implementations, aspects of the operations of 1004 may be performed by a RIC as described with reference to FIG. 4.

At 1006, the method may include transmitting an indication of an updated sampling rate for the one or more KPIs to the wireless access point. The operations of 1006 may be performed in accordance with examples as described herein. In some implementations, aspects of the operations of 1006 may be performed a RIC as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio intelligent controller (RIC) for wireless communication, comprising:
at least one memory; and
at least one processor coupled with the at least one memory and configured to cause the RIC to:
receive performance data of a key performance indicator (KPI); and
update a sampling rate of the KPI based at least in part on a determination to mitigate use of one or more operational resources of the RIC, the determination including a quantized risk evaluation for adjusting the sampling rate of the KPI.

2. The RIC of claim 1, wherein the at least one processor is configured to cause the RIC to transmit an indication of an updated sampling rate for the KPI to a network equipment (NE).

3. The RIC of claim 1, wherein the quantized risk evaluation assesses at least one of variation of the performance data of the KPI, or risk of the performance data of the KPI.

4. The RIC of claim 3, wherein a relatively low variation of the performance data correlates with a decreased sampling rate of the KPI, and wherein a relatively high variation of the performance data correlates with an increased sampling rate of the KPI.

5. The RIC of claim 3, wherein a relatively low risk of the performance data correlates with a decreased sampling rate of the KPI, and wherein a relatively high risk of the performance data correlates with an increased sampling rate of the KPI.

6. The RIC of claim 1, wherein the one or more operational resources of the RIC include at least one of processor performance, memory operations, data throughput, a bit rate, data bus bandwidth, energy consumption, or RIC performance.

7. The RIC of claim 1, wherein the update to the sampling rate of the KPI is based at least in part on the determination to mitigate use of one or more additional resources that include at least one of transport network performance, a user equipment (UE) performance, or wireless system performance.

8. The RIC of claim 1, wherein the one or more operational resources of the RIC include at least processor performance, and wherein the quantized risk evaluation assesses a combination of the performance data of the KPI and the processor performance of the RIC.

9. The RIC of claim 1, wherein the at least one processor is configured to cause the RIC to receive the performance data of multiple KPIs, and wherein the quantized risk evaluation assesses the performance data for a combination of KPIs of the multiple KPIs.

10. The RIC of claim 1, wherein the at least one processor is configured to cause the RIC to receive the performance data of the KPI via an open radio access network interface.

11. The RIC of claim 1, wherein the at least one processor is configured to cause the RIC to receive the performance data of the KPI from a network equipment (NE), and transmit an indication of an updated sampling rate for the KPI to the NE.

12. The RIC of claim 1, wherein the at least one processor is configured to cause the RIC to receive the performance data of the KPI from a user equipment (UE) via a wireless access point, and transmit an indication of an updated sampling rate for the KPI to the wireless access point.

13. The RIC of claim 1, wherein the KPI is associated with at least one of a physical (PHY) layer, a medium access control (MAC) layer, a radio link control (RLC) layer, a packet data convergence protocol (PDCP) layer, or a radio resource control (RRC) layer.

14. A processor for wireless communication, comprising:
at least one controller coupled with at least one memory and configured to cause the processor to:
receive performance data of a key performance indicator (KPI); and
update a sampling rate of the KPI based at least in part on a determination to mitigate use of one or more operational resources of a radio intelligent controller (RIC), the determination including a quantized risk evaluation for adjusting the sampling rate of the KPI.

15. The processor of claim 14, wherein the at least one controller is configured to cause the processor to transmit an indication of an updated sampling rate for the KPI to a network equipment (NE).

16. A method performed by a radio intelligent controller (RIC), the method comprising:
receiving performance data of one or more key performance indicators (KPIs); and
updating a sampling rate of at least one KPI based at least in part on a determination to mitigate use of one or more operational resources of the RIC, the determination including a quantized risk evaluation for updating the sampling rate of the at least one KPI.

17. The method of claim 16, wherein the quantized risk evaluation includes assessing variation of the performance data for a combination of the one or more KPIs.

18. The method of claim 16, wherein the one or more operational resources of the RIC include at least one of processor performance, memory operations, data throughput, a bit rate, data bus bandwidth, energy consumption, or RIC performance.

19. The method of claim 16, further comprising:
receiving the performance data of the one or more KPIs from a network equipment (NE); and
transmitting an indication of an updated sampling rate for the one or more KPIs to the NE.

20. The method of claim 14, further comprising:
receiving the performance data of the one or more KPIs from a user equipment (UE) via a wireless access point; and
transmitting an indication of an updated sampling rate for the one or more KPIs to the wireless access point.
